(19) United States
(12) Patent Application Publication
(10) Pub. No.: US 2009/0095782 A1
(43) Pub. Date: Apr. 16, 2009

(54) Carrying Rack for Car with Enhanced Stability

(76) Inventor: Yao-Huang Liu, Yung Kang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/869,905

(22) Filed: Oct. 10, 2007

(51) Int. Cl. B60R 9/10

(52) U.S. Cl. 224/502

(57) ABSTRACT

A carrying rack for a car includes a mounting sleeve, a plurality of locking members each extending through the mounting sleeve and each having a distal end extending into a mounting chamber of the mounting sleeve, a receiving seat mounted on the mounting sleeve, two main support bars each having a first end pivotally mounted in the receiving seat, and two pivotally connected crossbars each pivotally connected with a second end of a respective main support bar. The mounting sleeve is mounted on a ball of a support seat to encompass the ball completely, and the distal end of each of the locking members presses the periphery of the ball, so that the mounting sleeve is locked onto the ball by limit of the locking members to attach the carrying rack onto the support seat solidly and stably.

### BACKGROUND OF THE INVENTION

1. Field of the Invention

The present invention relates to a carrying rack and, more particularly, to a bike carrying rack for a car.

2. Description of the Related Art

A conventional carrying rack 1 for a car in accordance with the prior art shown in FIGS. 4 and 5 comprises two main support bars 10 each having a first end pivotally connected with one of two opposite ends of a connecting plate 11, two clamping members 13 each mounted on the first end of a respective main support bar 10 to move with the first end of the respective main support bar 10, and two crossbars 12 pivotally connected with each other and each having a distal end pivotally connected with a second end of a respective main support bar 10. When in use, the second ends of the main support bars 10 are movable outwardly relative to each other so that the main support bars 10 are pivoted about the connecting plate 11, and the first ends of the main support bars 10 are movable toward each other. Thus, the clamping members 13 are movable toward each other to clamp a ball 20 of a support seat 2 of a car between the clamping members 13 so that the main support bars 10 are locked onto the ball 20 of the support seat 2 by limit of the clamping members 13 to attach the carrying rack 1 onto the support seat 2.

However, the clamping members 13 do not clamp the ball 20 of the support seat 2 exactly and tightly due to an curvature deflection of the ball 20 of the support seat 2 or due to a size deflection of the neck portion 21 of the support seat 2, so that the clamping members 13 cannot clamp the ball 20 of the support seat 2 solidly and stably, and the carrying rack 1 produces vibration easily. In addition, the clamping members 13 and the connecting plate 11 are exposed outwardly, so that the clamping members 13 and the connecting plate 11 easily clamp or scratch a user, thereby causing danger to the user. Further, the clamping members 13 and the connecting plate 11 are exposed outwardly, thereby decreasing the outer appearance of the carrying rack 1.

### BRIEF SUMMARY OF THE INVENTION

In accordance with the present invention, there is provided a carrying rack, comprising a mounting sleeve having an inside having a mounting chamber, a plurality of locking members each extending through the mounting sleeve and each having a distal end extending into the mounting chamber of the mounting sleeve, a receiving seat mounted on the mounting sleeve, two main support bars each having a first end pivotally mounted in the receiving seat, and two crossbars pivotally connected with each other and each having a distal end pivotally connected with a second end of a respective main support bar.

The primary objective of the present invention is to provide a carrying rack for a car with an enhanced stability.

Another objective of the present invention is to provide a carrying rack for a car, wherein the mounting sleeve encompasses the ball of the support seat completely, and the distal end of each of the locking members presses the periphery of the lower portion of the ball of the support seat, so that the mounting sleeve is locked onto the ball of the support seat by limit of the locking members so as to attach the carrying rack onto the support seat solidly and stably without incurring any vibration and deflection.

A further objective of the present invention is to provide a carrying rack for a car, wherein the first end of each of the two main support bars is fully hidden in the receiving seat to prevent the first ends of the two main support bars from clamping or scratching a user during the pivotal action of the two main support bars so as to protect the user's safety.

A further objective of the present invention is to provide a carrying rack for a car, wherein the first end of each of the two main support bars is fully hidden in the receiving seat to enhance the aesthetic quality of the carrying rack.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a carrying rack for a car in accordance with the preferred embodiment of the present invention.

FIG. 2 is a front operational assembly view of the carrying rack for a car as shown in FIG. 1 in use.

FIG. 3 is a front exploded view of the carrying rack for a car as shown in FIG. 2.

FIG. 4 is a front view of a conventional carrying rack for a car in accordance with the prior art.

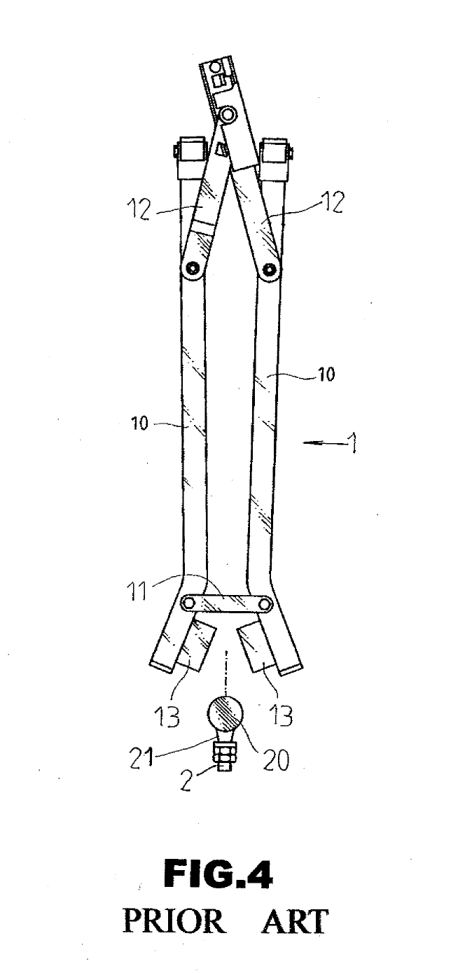

FIG. 5 is a folded view of the carrying rack for a car as shown in FIG. 4.

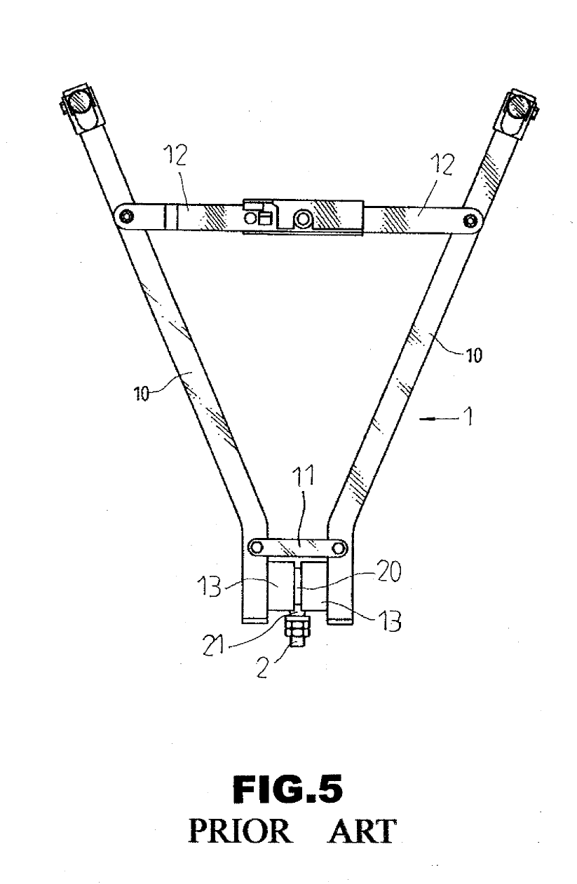

### DETAILED DESCRIPTION OF THE INVENTION

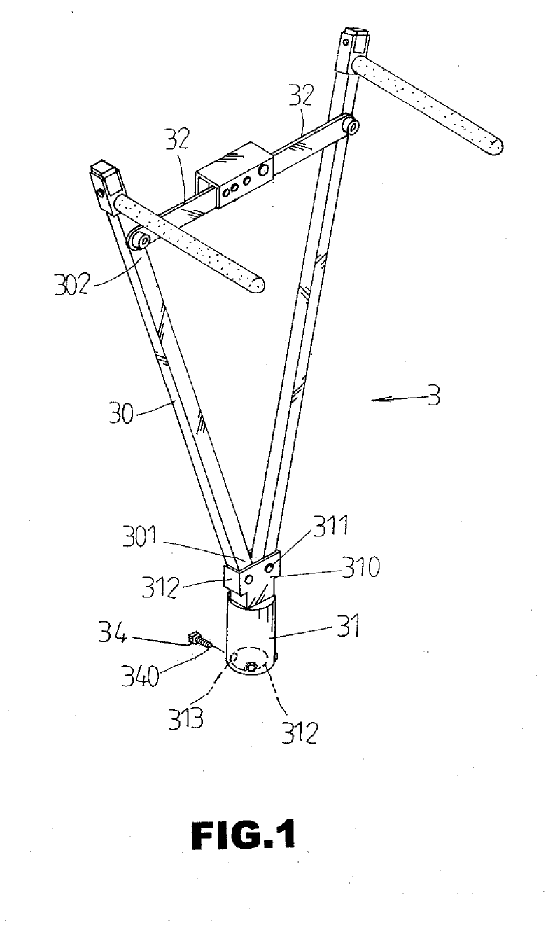

Referring to the drawings and initially to FIG. 1, a carrying rack 3 for a car in accordance with the preferred embodiment of the present invention comprises a mounting sleeve 31 having an inside having a mounting chamber 312, a plurality of locking members 34 each extending through the mounting sleeve 31 and each having a distal end 340 extending into the mounting chamber 312 of the mounting sleeve 31, a receiving seat 310 mounted on the mounting sleeve 31, two main support bars 30 each having a first end 301 pivotally mounted in the receiving seat 310, and two crossbars 32 pivotally connected with each other and each having a distal end pivotally connected with a second end 302 of a respective main support bar 30.

The mounting sleeve 31 has a substantially cylindrical shape, and the mounting chamber 312 of the mounting sleeve 31 has a substantially circular shape. The mounting sleeve 31 has a peripheral wall having a plurality of screw bores 313 each connected to the mounting chamber 312 of the mounting sleeve 31.

Each of the locking members 34 is a locking screw and is screwed into a respective screw bore 313 of the mounting sleeve 31. Preferably, the receiving seat 310 is mounted on a first end of the mounting sleeve 31, and the locking members 34 are mounted on a second end of the mounting sleeve 31 and located opposite to the receiving seat 310.

The receiving seat 310 has a peripheral wall having an enclosure 312 enclosed around the first end 301 of each of the two main support bars 30. Preferably, the enclosure 312 of the receiving seat 310 has a substantially rectangular shape.

The carrying rack 3 further comprises two pivot shafts 311 each extending through the receiving seat 310 and the first end 301 of a respective main support bar 30 so that the first end 301 of each of the two main support bars 30 is pivotally mounted in the receiving seat 310. Preferably, each of the pivot shafts 311 is a rivet and extends through the enclosure 312 of the receiving seat 310.

The first end 301 of each of the two main support bars 30 is fully hidden in the receiving seat 310. The first ends 301 of the main support bars 30 are pivotable about the pivot shafts 311 respectively and independently.

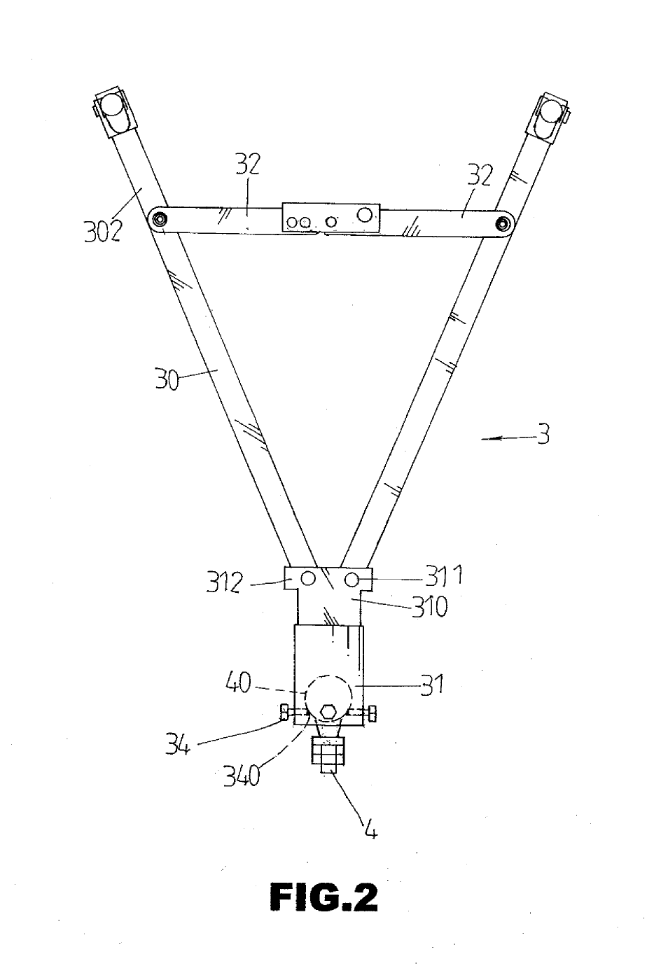

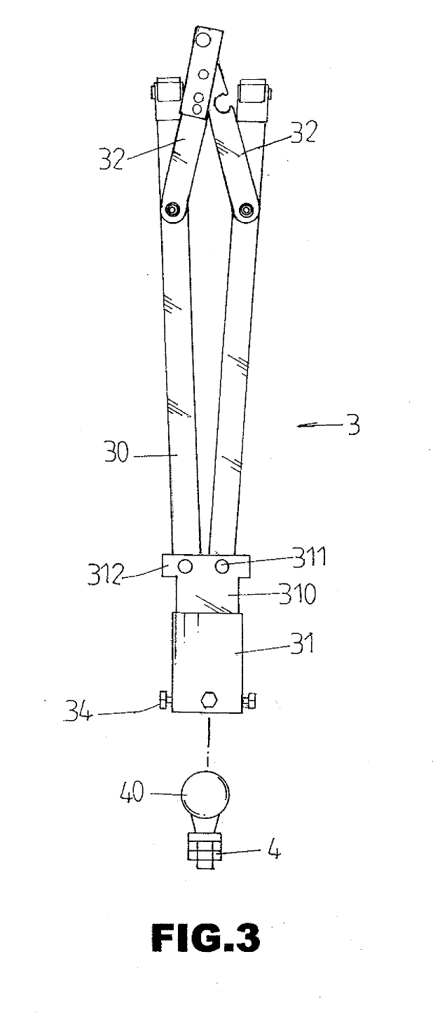

In operation, referring to FIGS. 2 and 3 with reference to FIG. 1, the mounting sleeve 31 is mounted on a ball 40 of a support seat 4 which is mounted on a rear trunk of a car, and each of the locking members 34 is screwed into a respective screw bore 313 of the mounting sleeve 31 until the distal end 340 of each of the locking members 34 is movable to rest on a periphery of a lower portion of the ball 40 of the support seat 4 as shown in FIG. 2, so that the mounting sleeve 31 is locked onto the ball 40 of the support seat 4 by limit of the locking members 34 so as to attach the carrying rack 3 onto the support seat 4.

When a user wishes to remove the carrying rack 3 from the support seat 4, the locking members 34 are unscrewed from the screw bores 313 of the mounting sleeve 31 until the distal end 340 of each of the locking members 34 is movable to detach from the ball 40 of the support seat 4, so that the ball 40 of the support seat 4 are unlocked from the locking members 34, and the mounting sleeve 31 can be removed from the ball 40 of the support seat 4 as shown in FIG. 3.

Accordingly, the mounting sleeve 31 encompasses the ball 40 of the support seat 4 completely, and the distal end 340 of each of the locking members 34 presses the periphery of the lower portion of the ball 40 of the support seat 4, so that the mounting sleeve 31 is locked onto the ball 40 of the support seat 4 by limit of the locking members 34 so as to attach the carrying rack 3 onto the support seat 4 solidly and stably without incurring any vibration and deflection. In addition, the first end 301 of each of the two main support bars 30 is fully hidden in the receiving seat 310 to prevent the first ends 301 of the two main support bars 30 from clamping or scratching a user during the pivotal action of the two main support bars 30 so as to protect the user's safety. Further, the first end 301 of each of the two main support bars 30 is fully hidden in the receiving seat 310 to enhance the aesthetic quality of the carrying rack 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A carrying rack, comprising:
a mounting sleeve having an inside having a mounting chamber;
a plurality of locking members each extending through the mounting sleeve and each having a distal end extending into the mounting chamber of the mounting sleeve;
a receiving seat mounted on the mounting sleeve;
two main support bars each having a first end pivotally mounted in the receiving seat;
two crossbars pivotally connected with each other and each having a distal end pivotally connected with a second end of a respective main support bar.

2. The carrying rack in accordance with claim 1, wherein each of the locking members is a locking screw.

3. The carrying rack in accordance with claim 2, wherein
the mounting sleeve has a peripheral wall having a plurality of screw bores each connected to the mounting chamber of the mounting sleeve;
each of the locking members is screwed into a respective screw bore of the mounting sleeve.

4. The carrying rack in accordance with claim 1, wherein
the receiving seat is mounted on a first end of the mounting sleeve;
the locking members are mounted on a second end of the mounting sleeve and located opposite to the receiving seat.

5. The carrying rack in accordance with claim 1, wherein the first end of each of the two main support bars is fully hidden in the receiving seat.

6. The carrying rack in accordance with claim 1, further comprising two pivot shafts each extending through the receiving seat and the first end of a respective main support bar so that the first end of each of the two main support bars is pivotally mounted in the receiving seat.

7. The carrying rack in accordance with claim 6, wherein each of the pivot shafts is a rivet.

8. The carrying rack in accordance with claim 6, wherein the receiving seat has a peripheral wall having an enclosure enclosed around the first end of each of the two main support bars.

9. The carrying rack in accordance with claim 8, wherein each of the pivot shafts extends through the enclosure of the receiving seat.

10. The carrying rack in accordance with claim 8, wherein the enclosure of the receiving seat has a substantially rectangular shape.

11. The carrying rack in accordance with claim 8, wherein the first ends of the main support bars are pivotable about the pivot shafts respectively and independently.

12. The carrying rack in accordance with claim 1, wherein the mounting sleeve has a substantially cylindrical shape.

13. The carrying rack in accordance with claim 1, wherein the mounting chamber of the mounting sleeve has a substantially circular shape.

14. The carrying rack in accordance with claim 1, wherein
the mounting sleeve is mounted on a ball of a support seat;
the distal end of each of the locking members is movable to rest on a periphery of a lower portion of the ball of the support seat;
the mounting sleeve is locked onto the ball of the support seat by limit of the locking members.

15. The carrying rack in accordance with claim 14, wherein
the mounting sleeve encompasses the ball of the support seat completely;
the distal end of each of the locking members presses the periphery of the lower portion of the ball of the support seat.
